(19) United States
(12) Patent Application Publication
(10) Pub. No.: US 2022/0334584 A1
(43) Pub. Date: Oct. 20, 2022

(54) METHOD AND SYSTEM FOR MAKING WORK PLAN FOR CONSTRUCTION MACHINERY

(71) Applicant: HYUNDAI DOOSAN INFRACORE CO., LTD., Dong-gu (KR)

(72) Inventors: Junhyun JANG, Dong-gu (KR); Heongsik UM, Dong-gu (KR); Gijung Yun, Dong-gu (KR)

(21) Appl. No.: 17/720,447

(22) Filed: Apr. 14, 2022

(30) Foreign Application Priority Data
Apr. 14, 2021 (KR) 10-2021-0048405

(51) Int. Cl. G05D 1/02; G05D 1/00

(52) U.S. Cl. CPC G05D 1/0219; G05D 1/0094; G05D 1/0027; G05D 2201/0202

(57) ABSTRACT

In a method of making a work plan for construction machinery, construction site information including an orthographic image and work data are provided. A trench excavation work plan on the orthographic image is set based on the work data. The trench excavation work plan is configured to displays a work route line and a work position of construction machinery based on the work route line. The trench excavation work plan is transmitted to a worker terminal.

### CROSS-REFERENCE TO RELATED APPLICATIONS

This application claims priority under 35 U.S.C. § 119 to Korean Patent Application No. 10-2021-0048405, filed on Apr. 14, 2021 in the Korean Intellectual Property Office (KIPO), the contents of which are herein incorporated by reference in their entirety.

### FIELD

Example embodiments relate to a method and a system for making a work plan for construction machinery. More particularly, example embodiments relate to a method of making a work plan of a trench excavation using an excavator, and a system for making a work plan using the same.

### BACKGROUND

A work plan for a Machine Guidance and a Machine Control may be provided as simple 3D design drawings. In this case, operators may work while checking plan drawings and an operation of equipment in real time, but operators have to determine and establish the work plan by themselves. Therefore, since the work plan is not standardized, problems may arise when collaborating with unskilled workers and another equipment engineer. Further, even in a case of a fully automatic excavator, there may be a limitation using the automatic excavator because a work area can be expressed only for limited work.

### SUMMARY

Example embodiments provide a work planning system for construction machinery capable of sharing a work plan among workers, more accurately.

Example embodiments provide a method of making a work plan for construction machinery capable of sharing a work plan among workers using the work planning system.

According to example embodiments, in a method of making a work plan for construction machinery, construction site information including an orthographic image and work data are provided. A trench excavation work plan on the orthographic image is set based on the work data. The trench excavation work plan is configured to displays a work route line and a work position of construction machinery based on the work route line. The trench excavation work plan is transmitted to a worker terminal.

In example embodiments, in order to set the trench excavation work plan, a plurality of sequence points on the orthographic image may be set, a sequence number for each sequence point may be set by reflecting a work sequence, and the work route line may be set by connecting the sequence points according to the sequence number.

In example embodiments, in order to set the trench excavation work plan, a cross-sectional shape for the sequence points may be set.

In example embodiments, in order to set the cross-sectional shape dimensions for a bottom width, a bottom elevation, a slope inclination and top width of the cross-sectional shape may be set, and a construction tolerance range for the bottom and the slope may be set.

In example embodiments, the orthographic image may include a reference coordinate, and the work route line and the work position of the construction machinery may be set based on the reference coordinate.

In example embodiments, setting the trench excavation work plan on the orthographic image may further include displaying on a screen by overlaying an earthwork drawing on the orthographic image.

In example embodiments, setting the trench excavation work plan may further include setting a moving direction of a vehicle to load soil or a filling direction of the soil by reflecting the work position of the construction machinery.

In example embodiments, the construction machinery may be an automatic excavator and the worker terminal may be provided in the automatic excavator to control an operation of the automatic excavator.

In example embodiments, setting the trench excavation work plan may further include setting a manned work area or a remoted work area.

According to example embodiments, a work planning system for construction machinery may include a server configured to store construction site information including an orthographic image and work data, and including a work planning portion to set a trench excavation work plan on the orthographic image using the work data, the trench excavation work plan displaying a work route line and a work position of construction machinery based on the work route line, and at least one worker terminal configured to receive the set trench excavation work plan from the server.

In example embodiments, the work planning portion may include a planar design unit to set a plurality of sequence points having sequence numbers reflecting a work sequence on the orthographic image and to set the work route line by connecting the sequence points according to the sequence numbers.

In example embodiments, the work planning portion may further include a cross-section design unit to set a cross-sectional shape of the sequence points.

In example embodiments, the cross-section design unit may set dimension for a bottom width, a bottom elevation, a slope inclination and top width of the cross-sectional shape, and the work planning portion sets a construction tolerance range for the bottom and the slope.

In example embodiments, the orthographic image may include a reference coordinate, and the work route line and the work position of the construction machinery may be set based on the reference coordinate.

In example embodiments, the worker terminal may display on a screen by overlaying an earthwork drawing on the orthographic image.

In example embodiments, the work planning portion may include a soil treatment setting unit to set a moving direction of a vehicle to load soil or a filling direction of the soil by reflecting the work position of the construction machinery.

In example embodiments, the construction machinery may be an automatic excavator and the worker terminal may be provided in the automatic excavator to control an operation of the automatic excavator.

In example embodiments, the work planning portion may include a manned work section setting unit to set a manned work area or a remoted work area.

According to example embodiments, in a method of making a work plan for construction machinery, construction site information including work data and an orthographic image having a reference coordinate are provided. A trench excavation work plan on the orthographic image is set by using the work data, the trench excavation work plan displaying a work route line and a work position of construction machinery based on the work route line based on the reference coordinate. The trench excavation work plan is transmitted to a worker terminal. In order to set the trench excavation work plan, a plurality of sequence points may be set on the orthographic image. A sequence number may be set by reflecting a work sequence for each sequence point. The work route line may be set by connecting the sequence points according to the sequence number.

According to example embodiments, in a method of making a work plan for construction machinery, construction site information including an orthographic image and work data may be provided. A trench excavation work plan may be set on the orthographic image based on the work data, the trench excavation work plan displaying a work route line and a work position of construction machinery based on the work route line. The trench excavation work plan may be transmitted to a worker terminal.

Accordingly, a more standardized and uniform work detail may be created. In addition, it may be possible to more accurately share the trench excavation work plan among related parties such as excavation construction managers including excavator drivers. Furthermore, it may be possible to give more precise commands to fully automatic excavators.

However, the effect of the inventive concept may not be limited thereto, and may be expanded without being deviated from the concept and the scope of the present disclosure.

### BRIEF DESCRIPTION OF THE DRAWINGS

Example embodiments will be more clearly understood from the following detailed description taken in conjunction with the accompanying drawings.

FIG. 1 is a block diagram illustrating a work planning system for construction machinery in accordance with example embodiments.

FIG. 2 is a view illustrating a display device of a server in FIG. 1.

FIG. 3 is a block diagram illustrating a project register in FIG. 1.

FIG. 4 is a block diagram illustrating a work planning portion in FIG. 1.

FIG. 5 is a view illustrating a reference coordinate set on a background overlaid with an orthographic image and a construction drawing.

FIG. 6 is a view illustrating a plurality of sequence points.

FIG. 7 is a view illustrating a work route line connecting sequence points.

FIG. 8 is a view illustrating a cross-sectional line.

FIG. 9 is a view illustrating a cross-sectional shape set for sequence points.

FIG. 10 is a view illustrating a shape of a work area having a three-dimensional coordinate.

FIG. 11 is a view illustrating a set construction tolerance range.

FIG. 12 is a view illustrating a work position of construction machinery based on a work route line.

FIG. 13 is a view illustrating a moving direction of a vehicle to load soil or a filling direction of soil.

FIG. 14 is a view illustrating a manned work area.

FIG. 15 is a flow chart illustrating a method of making a work plan for construction machinery by using the work planning system in FIG. 1.

FIG. 16 is a flow chart illustrating a method of setting a trench excavation work plan in FIG. 15.

### DETAILED DESCRIPTION

Hereinafter, preferable embodiments of the present disclosure will be explained in detail with reference to the accompanying drawings.

In the drawings, the sizes and relative sizes of components or elements may be exaggerated for clarity.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art.

FIG. 1 is a block diagram illustrating a work planning system for construction machinery in accordance with example embodiments. FIG. 2 is a view illustrating a display device of a server in FIG. 1.

Referring to FIGS. 1 and 2, in example embodiments, a work planning system 10 for construction machinery may include at least one worker terminal 50 and a server 100.

In example embodiments, the work planning system 10 may be applied to the construction machinery. For example, the work planning system 10 may be applied to an excavator. However, the work planning system 10 may be applied to various construction machines other than the excavator.

In example embodiments, the worker terminal 50 may receive a trench excavation work plan to be described later from the server 100. The worker terminal 50 may be referred to as a mobile terminal owned by each worker at a construction site. Alternatively, the worker terminal 50 may be installed in the construction machinery to display the trench excavation work plan on a screen. In addition, the worker terminal 50 may perform a Machine Guidance function or a Machine Control function. When the construction machinery is an automatic excavator, the worker terminal 50 may be provided in the automatic excavator to serve as a part of a control device for controlling an operation of the automatic excavator.

In example embodiments, the server 100 may include a display device 110 for displaying the trench excavation work plan, a communication device 130 for transmitting and receiving data with the worker terminal 50, a project register 200 for registering a project at the construction site, and a work planning portion 400 for creating the trench excavation work plan.

A communication network connecting the server 100 and the worker terminal 50 may include a network established by a mobile communication service provider. Alternatively, the communication network may include a device such as an Access Point (AP). For example, the AP may be a short-distance communication device, and may serve as a router performing a wireless communication function between the APs. The AP may be a short-range wireless communication technology supporting device having a function of a gateway supporting connection as a wired network. As an example, the communication network equipment may be installed at regular intervals in each area of the construction site to enable wireless short-distance communication within a predetermined zone.

The server 100 may receive data for setting the trench excavation work plan from an administrator. The data may be directly input by the administrator to the server 100 or may be input through a separate administrator terminal.

In addition, the server 100 may transmit the trench excavation work plan to the worker terminal 50 provided in the construction machinery or owned by the worker through the communication device 130. The server 100 may transmit the trench excavation work plan to an administrator terminal owned by the administrator and the worker terminal 50 owned by the worker. The server 100 may transmit the trench excavation work plan to the machine guidance or the machine control installed in the construction machinery. In addition, the server 100 may monitor the construction machinery in order to check whether the construction machinery works according to the trench excavation work plan at the construction site.

As illustrated in FIG. 2, the trench excavation work plan may be displayed on a map 120 constituting the display device 110. In addition, the display device 110 may display the project register 200, a monitoring portion 300 and the work planning portion 400 on the screen.

In example embodiments, the project register 200 may register a project to which the construction machinery is to be applied. In particular, a project to be completed through a use of the excavator may be registered through the display device 110. The monitoring portion 300 may monitor whether or not the excavator works according to the trench excavation work plan. The work planning portion 400 may make a work plan to work with the excavator. For example, functions of the project register 200, the monitoring portion 300 and the work planning portion 400 may be executed through the display device 110.

In example embodiments, the monitoring portion 300 may include an equipment monitoring portion 310 and a field monitoring portion 320.

The equipment monitoring portion 310 may monitor a location of the construction machinery on the map 120. The equipment monitoring portion 310 may monitor equipment status, such as equipment basic information, fuel information, instrument information, operating time information, and the like. The equipment monitoring portion 310 may monitor a status of equipment currently working in a transmitted work plan group.

The field monitoring portion 320 may monitor a progression level compared to planned mounding amount, a progress degree compared to planned cutting amount, a progress degree compared to total earthwork volume of the construction site.

FIG. 3 is a block diagram illustrating a project register in FIG. 1.

Referring to FIG. 3, the project register 200 may include a project basic information registration/editing unit 210, a project area registration/editing unit 220, an orthographic image registration unit 230, an earthwork drawing registration unit 240, an equipment information registration/editing unit 250 and a geo-fencing registration/editing unit 260. The project register 200 may register construction site information. The construction site information may include an orthographic image and all necessary information for the construction site.

The project basic information registration/editing unit 210 may register and edit basic information of the project. For example, the project basic information registration/editing unit 210 may register and edit information of an address, period, ordering entity, and construction company of the project.

The project area registration/editing unit 220 may designate and edit a project area by inputting an outer region of the project area on the map 120.

The orthographic image registration unit 230 may register an image of the construction site. For example, the orthographic image registration unit 230 may register an aerial image captured at the construction site using an aircraft, a satellite, or a drone. The image of the construction site registered by the orthographic image registration unit 230 may be displayed on the map 120.

The earthwork drawing registration unit 240 may register an earthwork drawing of the construction site. The earthwork drawing of the construction site registered by the earthwork drawing registration unit 240 may be displayed on the map 120. The earthwork drawing may be an earthwork target drawing in which an earthwork target is displayed.

The equipment information registration/editing unit 250 may register and edit information on construction equipment. For example, the equipment information registration/editing unit 250 may register and edit a model name, a unique number, a basic specification, and the like of the construction machinery.

The geo-fencing registration/editing unit 260 may register and edit main areas of the construction site. For example, the geo-fencing registration/editing unit 260 may register and edit major areas, such as a dangerous area of the construction site, a graveyard, a highway, and the like, on the map 120.

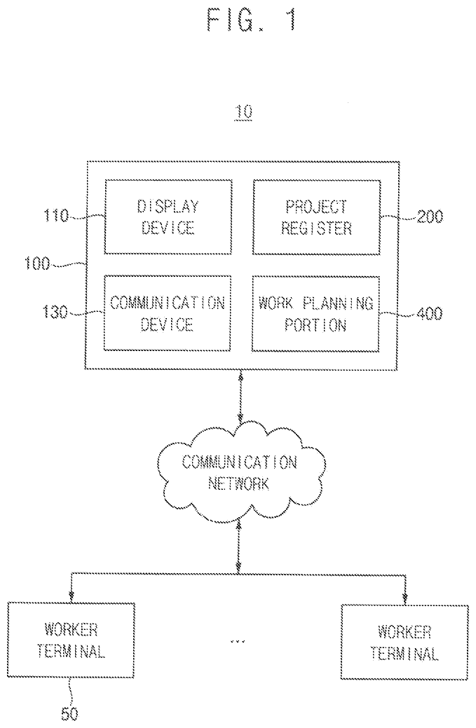

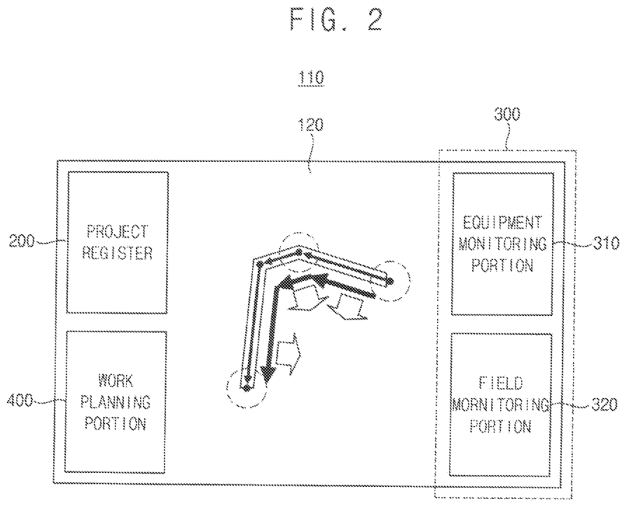

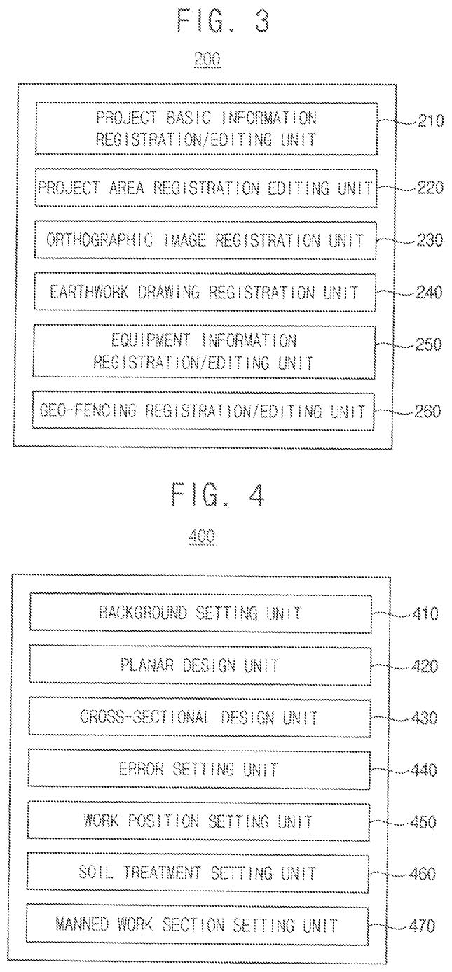

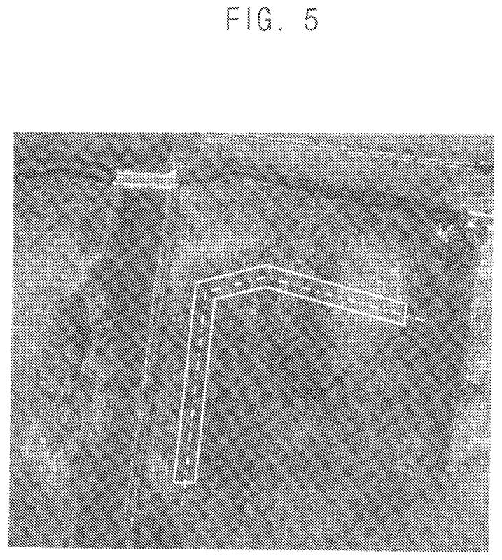

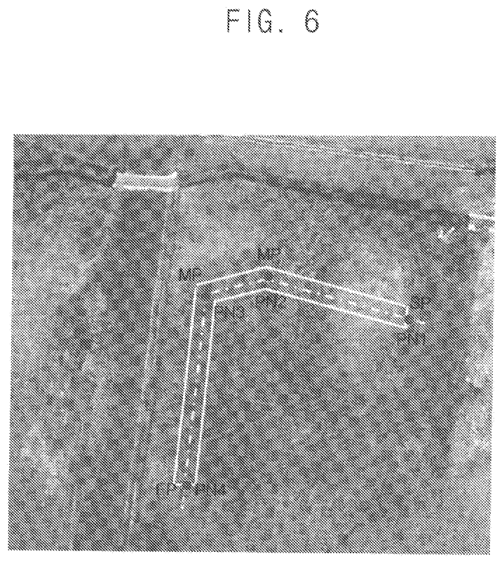

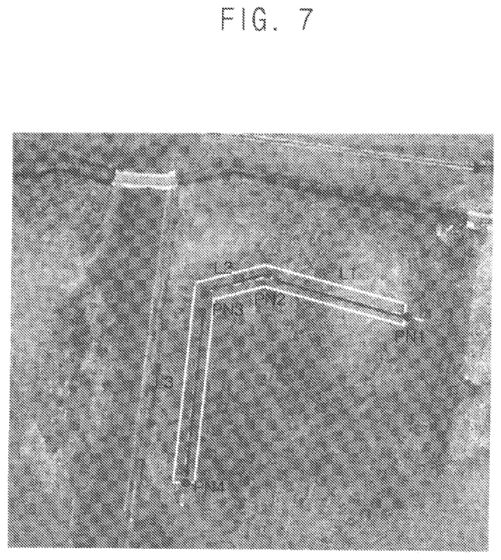

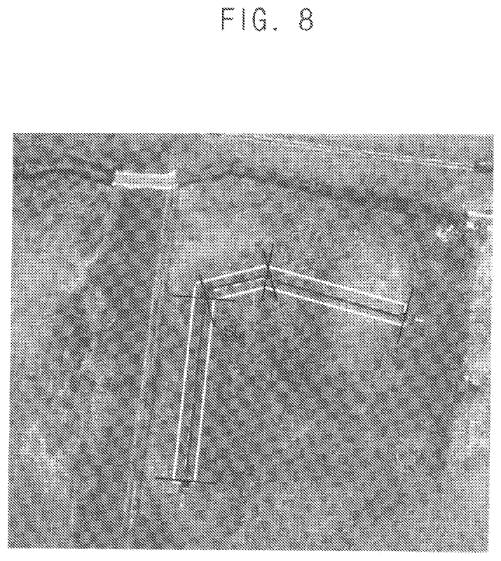

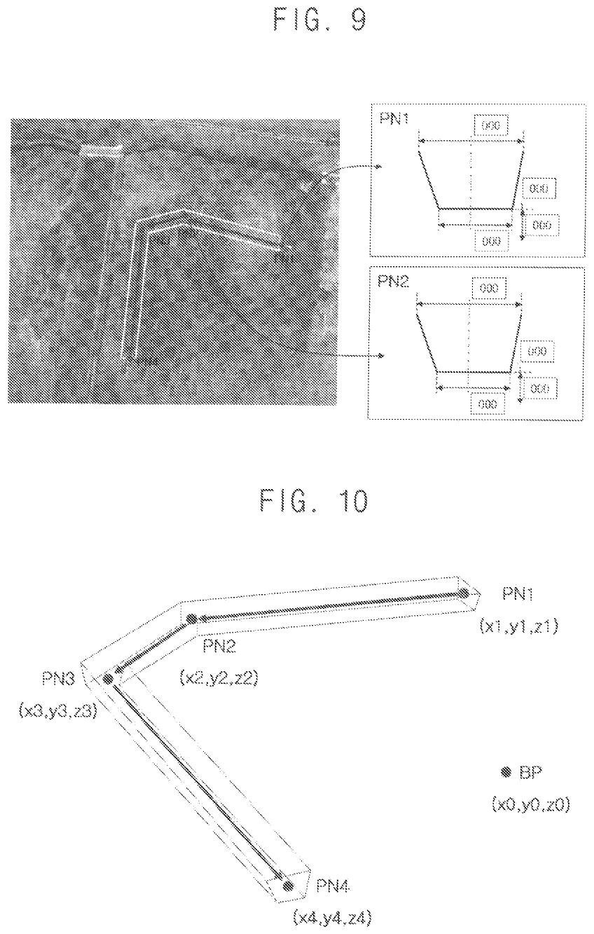

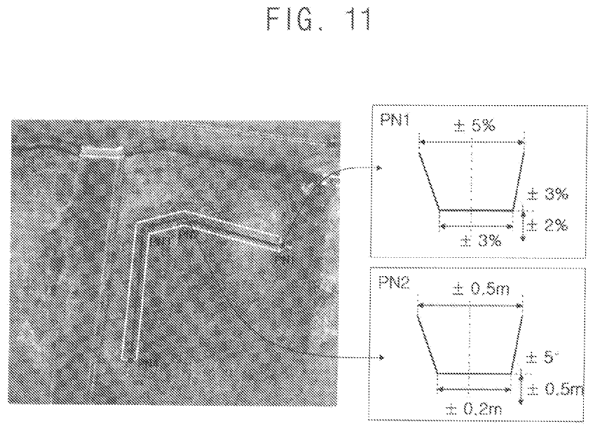

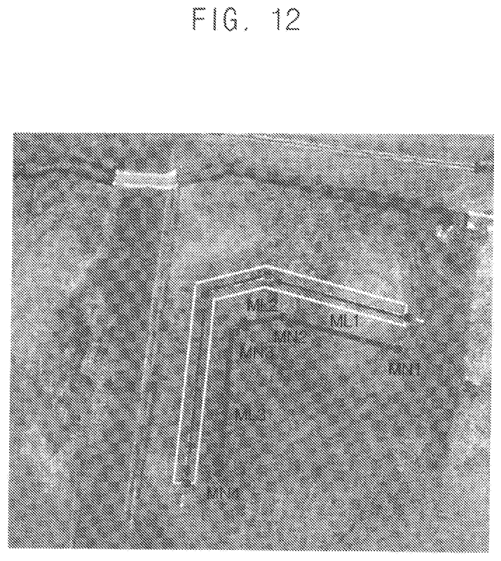

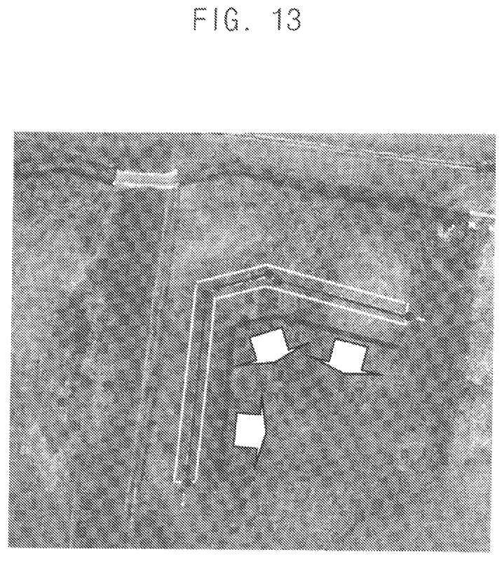

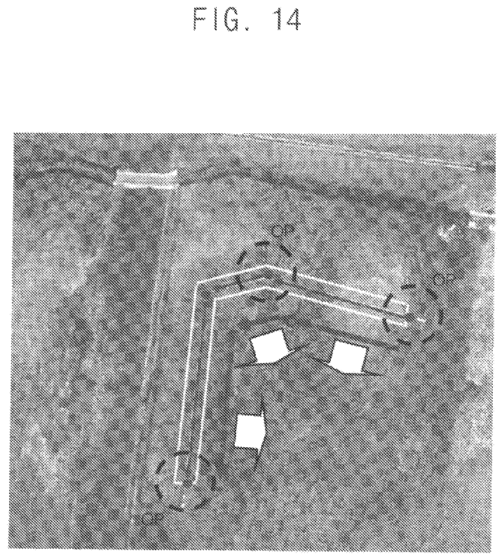

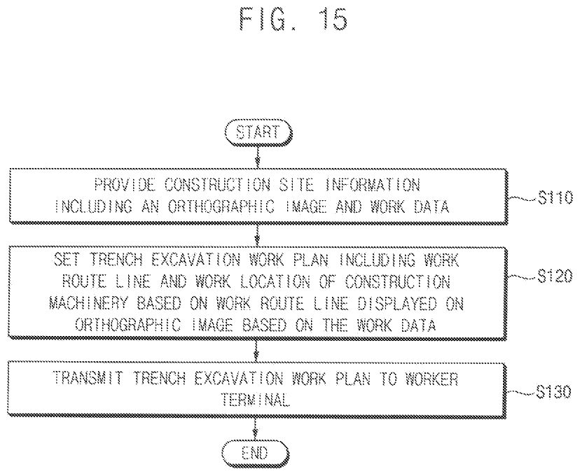

FIG. 4 is a block diagram illustrating a work planning portion in FIG. 1. FIG. 5 is a view illustrating a reference coordinate set on a background overlaid with an orthographic image and a construction drawing. FIG. 6 is a view illustrating a plurality of sequence points. FIG. 7 is a view illustrating a work route line connecting sequence points. FIG. 8 is a view illustrating a section line. FIG. 9 is a view illustrating a cross-sectional shape set for sequence points. FIG. 10 is a view illustrating a shape of a work area having a three-dimensional coordinate. FIG. 11 is a view illustrating a set construction tolerance range. FIG. 12 is a view illustrating a work position of construction machinery based on a work route line. FIG. 13 is a view illustrating a moving direction of a vehicle to load soil or a filling direction of soil. FIG. 14 is a view illustrating a manned work area where a manned operation is required.

Referring to FIGS. 4 to 14, the work planning portion 400 may include a background setting unit 410, a planar design unit 420, a cross-sectional design unit 430, an error setting unit 440, a work position setting unit 450, a soil treatment setting unit 460 and a manned work section setting unit 470. The work planning portion 400 may register work data for creating the trench excavation work plan.

In example embodiments, the work planning portion 400 may create the trench excavation work plan for implementing a trench excavation using the excavator. For example, a trench excavation work may be referred to as an excavation method in which a length of a trench formed by removing the soil from the ground greatly exceeds a depth of the trench. The trench excavation work plan may be set by the work data input by the administrator. The work data may include data on a plurality of sequence points, a work route line, a cross-sectional shape and a work position of the construction machinery as will be described later. The work data may further include data on a construction tolerance range.

The work planning portion 400 may create a work plan group by grouping created work plans. For example, the work plan group may be determined based on a certain area within the construction site. Alternatively, the work plan group may be determined based on an order of construction work.

Accordingly, a detailed work order may be determined according to travelling routes and work areas included in each work plan group. The work plan group created by the work planning portion 400 may be transmitted to the worker terminal installed in the construction machinery or owned by the worker or the administrator terminal owned by the administrator. The worker may perform the work by adjusting the construction machinery according to the detailed work order of the work plan group.

As illustrated in FIG. 5, the background setting unit 410 may select a background of the construction site including a reference coordinate.

In example embodiments, the background setting unit 410 may select a background on which the trench excavation work plan is displayed. The background may include the orthographic image. The background may additionally include the earthwork drawing. The background may be displayed on the map 120 of the display device 110.

For example, the orthographic image may be an image obtained by an aerial photograph, an artificial satellite, a drone, or the like. The orthographic image may be referred to as an image obtained when all objects are viewed vertically after correcting geometric distortion caused by terrain undulations (height difference, inclination) of a construction site. The orthographic image may be an image map in which a coordinate and periods are added. The orthographic image may include distance information of a construction site, location information of a geographical feature, information about an area, and the like.

In example embodiments, the background may include the reference coordinate BP. The reference coordinate BP may be designated as a specific point on the orthographic image. For example, the constant point may be a point selected based on a center of the construction site. The reference coordinate BP may be referred to as a reference point for collectively expressing each location in construction plan preparation.

In example embodiments, the background setting unit 410 may overlay the orthographic image and the earthwork drawing. The overlaid orthographic image and earthwork drawing may include the same reference coordinate BP and may have a same coordinate at a same point. The overlaid orthographic image and earthwork drawing may be displayed on the screen of the worker terminal 50.

As illustrated in FIG. 6, the planar design unit 420 may select a plurality of the sequence points on the background. The sequence points may correspond to points selected based on the reference coordinate BP on the orthographic image.

For example, the sequence point may be a point at which an operation is performed. The sequence point may include a point at which the work starts, a point at which the work ends, a point at which the work changes, and the like. As will be described later, since the sequence point is a reference for setting the cross-sectional shape, a point at which the cross-sectional shape is changed may be set as the sequence point.

In example embodiments, the sequence point may include a starting point SP and an ending point EP. The starting point SP may be a point at which the construction work starts, and the ending point EP may be a point at which the construction work ends. For example, the starting point SP or the ending point EP may be set based on the same reference coordinate BP.

In example embodiments, a middle point MP may be positioned between the starting point SP and the ending point EP. The middle point MP may be a change point of the work in the construction work. For example, the change point may be a point at which a direction of the work is changed, a point at which a content of the work is changed, and the like.

For example, the sequence points may be input according to the work order, the planar design unit 420 may set a first input sequence point as the starting point SP and a last input sequence point as the ending point EP.

The planar design unit 420 may sequentially assign a unique number to each of the sequence points. For example, the sequence points may be assigned the unique number PN1, PN2, PN3, PN4 according to the work order in which the construction work is performed.

As illustrated in FIG. 7, the planar design unit 420 may set the work route line connecting the sequence points. The work route line may be connected according to the sequence of the unique numbers PN1, PN2, PN3, PN4 of the sequence points assigned sequentially. The work route line may be formed of a straight line or a curved line.

For example, the work route line connecting the sequence points may be expressed in an arrow direction according to the order in which the construction work is performed. The arrow direction may be expressed from the sequence point at which a pre-work is performed to the sequence point at which a post-work is performed.

The planar design unit 420 may assign the unique number to the work route line connecting the sequence points. The work route line may be sequentially assigned the unique number L1, L2, L3 according to the order in which the construction work is performed.

As illustrated in FIG. 8, in example embodiments, the planar design unit 420 may display a section line SL orthogonal to the work route line at each of the sequence points. The section line SL may clarify a starting point, a changing point, and an ending point of the construction work. The section line SL may clarify a work area of the work route line. For example, the section line SL may be displayed such that the sequence point is located at a center of the section line.

As illustrated in FIG. 9, the cross-sectional design unit 430 may set a cross-sectional shape for each of the sequence points. Specifically, the cross-sectional shape may be set based on each of the sequence points input by the administrator.

In example embodiments, the cross-sectional design unit 430 may set a specific dimension for the cross-sectional shape. The specific dimension may be obtained from the work data input by the administrator.

In example embodiments, when the construction work is to implement the trench excavation using the excavator, the cross-sectional design unit 430 may set the dimension for a bottom width, a bottom elevation, a slope inclination and a top width of the cross-sectional shape.

As illustrated in FIG. 10, the cross-sectional design unit 430 may create a work area shape with a three-dimensional coordinate composed of top, bottom and both sides by connecting the cross-sectional shape input to each sequence point along the work route line on a plane.

Specifically, the work area shape may be created by connecting a top surface, a bottom surface and both side surfaces constituting the cross-section shape of each sequence point in a direction of the work route line. Each dimension of the top surface, the bottom surface and both side surfaces may be obtained based on the dimension of the cross-sectional shape input based on the sequence points.

For example, the three-dimensional coordinate may be set based on the reference coordinate BP (x0, y0, z0). The work area on the plane may be expressed based on the coordinate of the top surface of the work area shape. The work area shape may be transmitted through the communication device 130 to the terminal installed in the construction machinery, the mobile terminal owned by the administrator, etc.

As illustrated in FIG. 11, the error setting unit 440 may set a construction tolerance range. The construction tolerance range may include an error range of all dimensions that may occur in a process of performing the construction work.

In example embodiments, the construction tolerance range may include errors with respect to positions of the sequence points and errors with respect to positions of the work route line. The construction tolerance range may include an error with respect to the set dimension of the cross-sectional shape. The construction tolerance range may indicate a degree of protrusion in the bottom surface and a slope constituting the cross-sectional shape. The construction tolerance range may be set in an absolute unit such as a distance (m) or may be set in a relative unit such as a ratio (%).

In example embodiments, when the construction work is to implement the trench excavation, the construction tolerance range may include an error range for the bottom width, the bottom elevation, the slope inclination and the top width of the cross-sectional shape. In addition, the construction tolerance range may include an error range for the protrusion degree in the bottom surface and the slope.

As illustrated in FIG. 12, the work position setting unit 450 may set a work position of the construction machinery based on the work route line. The work position may be designated as a specific point. The work position may include a movement route of the construction machinery. The work position may be set based on the reference coordinate BP.

In example embodiments, the work position may be set by reflecting a specification of the construction machinery. For example, when the construction machinery is the excavator, the work position may be designated by reflecting the specification of the excavator. The specification of the excavator may include a type of the excavator, a size of the excavator, lengths of a bucket, an arm and a boom of the excavator, etc.

In example embodiments, the work position setting unit 450 may create and edit the movement route of the construction machinery. The work position setting unit 450 may set the movement route of the construction machinery on the orthographic image. The work position setting unit 450 may set the position of the construction machinery to any one of a left, a right and a center based on the work route line set by the planar design unit 420.

The work position setting unit 450 may designate a plurality of movement points including a starting point MN1 and an ending point MN4 of the movement route. The work position setting unit 450 may designate way points between the starting point MN1 and the ending point MN4 of the movement route. The way points MN2, MN3 may be designated when the construction machinery is stopped, changes the direction, and works in progress. For example, the administrator may input a plurality of the movement points according to the work order, and the work position setting unit 450 may set a first input movement point as the starting point MN1 and a last input movement point as the ending point MN4.

The work position setting unit 450 may represent a movement line connecting the starting point MN1, the way points MN2, MN3 and the ending point MN4 along the movement route. The movement line may be expressed in the direction of the arrow according to a progress sequence in which the construction work is performed. The direction of the arrow may be expressed from the point at which a pre-work is performed to the point at which a post-work is performed along the movement line.

The work position setting unit 450 may assign a unique number to the movement line. The unique number ML1, ML2, ML3 may be sequentially assigned to the movement line according to the order in which the construction work is performed.

The work position setting unit 450 may register movement route attribute information of the construction machinery. For example, conditions including a movement speed of the excavator, forward/backward, an angle of the upper swing body of the excavator, a front state of the excavator, etc., may be registered.

The registration of the movement route attribute information may designate an attribute value of the movement route, for example, moving speed, moving direction, and location of the bucket. The moving speed of the construction machinery may be determined based on a numerical value determined through the equipment information registration/editing unit 250. In addition, the main areas of registered geo-fencing and the construction sites may be overlaid on the plane and utilized to secure the safe and efficient movement route.

As illustrated in FIG. 13, the soil treatment setting unit 460 may set a soil treatment method, and may set a moving direction of a vehicle to load soil or a filling direction of the soil by reflecting the work position of the construction machinery.

In example embodiments, the soil treatment method may include loading the soil on a cargo vehicle, transporting the soil by the cargo vehicle and filling a built-up soil.

When the soil treatment method is to load and transport the cargo vehicle for transport, the moving direction of the cargo vehicle for transport may be specified. When specifying the moving direction of the cargo vehicle for transport, the soil treatment setting unit 460 may set the moving direction by reflecting the work position of the designated construction machinery based on the work route line.

The soil treatment setting unit 460 may designate the moving direction of a loading box constituting the cargo vehicle for transport. Specifically, it may be possible to designate the forward/backward moving direction of the cargo vehicle for transport.

When the soil treatment method is to form an embankment, a formation direction of the embankment may be specified. When the formation direction of the embankment is specified, the soil treatment setting unit 460 may be set by reflecting the work position of the construction machinery designated based on the work route line.

As illustrated in FIG. 14, the manned work section setting unit 470 may designate a manned work area or a remoted work area. The manned work section setting unit 470 may input a work detail for the manned work area or the remoted work area.

In example embodiments, the construction machinery may be the excavator, and the excavator may be the automatic excavator. When the excavator is the automatic excavator, the work area may be classified as the manned work area or the remoted work area. The remoted work area may be the work area requiring precise work or dangerous work. When the excavator is the automatic excavator, the worker terminal 50 may be provided in the automatic excavator to control the operation of the automatic excavator.

The manned work section setting unit 470 may designate the manned work area OP by reflecting the work route line connecting the sequence points and the cross-sectional shape of the sequence points. The manned work section setting unit 470 may designate the manned work area OP by reflecting the work position of the construction machinery. The manned work section setting unit 470 may designate the manned work area OP by reflecting a set work range of the construction machinery.

Hereinafter, a method of making the work plan by using the work planning system for the construction machinery in FIG. 1 will be explained.

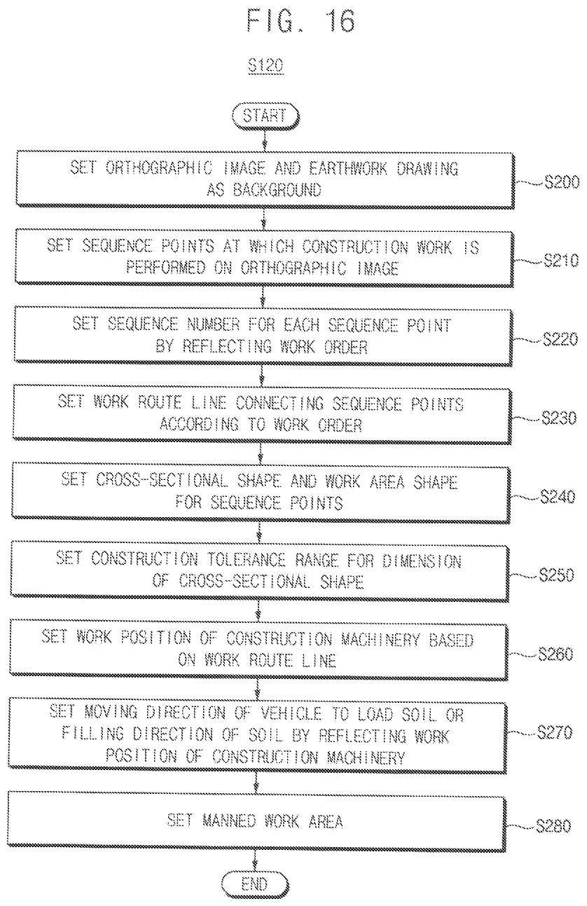

FIG. 15 is a flow chart illustrating a method of making a work plan for construction machinery by using the work planning system in FIG. 1. FIG. 16 is a flow chart illustrating a method of setting a trench excavation work plan in FIG. 15.

Referring to FIGS. 1 to 15, first, construction site information including an orthographic image and work data may be provided (S110). The construction site information and the work data may be processed in a project register 200 and a work planning portion 400.

In example embodiments, the construction site information and the work data may be registered in a server 100 by an administrator. In order to set a trench excavation work plan, the registered construction site information and the work data may be provided from the server 100.

In example embodiments, the construction site information may include basic information of a construction project. For example, the orthographic image captured at the construction site using a manned aircraft, a satellite, or a drone may be registered, and an earthwork drawing indicating earthwork work goals at the construction site may be registered. In addition, an outer region of a project area may be input and a model name, a unique number, a basic specification, etc. of the construction machinery may be registered and edited.

In example embodiments, the project register 200 may store the construction site information for the trench excavation work plan input by the administrator. The stored construction site information may be utilized to create the trench excavation work plan. The construction site information may include the orthographic image and the earthwork drawing. The orthographic image and the earthwork drawing may include a reference coordinate BP.

In example embodiments, the server 100 may receive the work data from the administrator. The administrator may directly input the work data to the server 100, or may input the work data to the server 100 by transmitting the work data through a separate terminal. The work data may include information for creating the trench excavation work plan. The work data may include data about a plurality of sequence points, a work route line, a cross-sectional shape, a work position of the construction machinery, and a construction tolerance range.

Then, the trench excavation work plan including the work route line and the work location of the construction machinery based on the work route line displayed on the orthographic image may be set based on the work data (S120).

In example embodiments, the step of setting the trench excavation work plan may be processed in a work planning portion 400 of the server 100. The trench excavation work plan may be set through the work data input by the administrator.

As will be described later, setting the trench excavation work plan may include setting a plurality of the sequence points on the orthographic image, setting the sequence number for each of the sequence points, setting the work route line, setting the cross-sectional shape, setting each dimension for the cross-sectional shape, setting the construction tolerance range, setting the work position of the construction machinery, setting a moving direction of a vehicle to load soil or a filling direction of the soil, and setting a manned work area.

Then, the trench excavation work plan may be transmitted to the worker terminal (S130).

In example embodiments, the worker terminal 50 may receive the set trench excavation work plan from the server 100. The worker terminal 50 may refer to a mobile terminal owned by workers at the construction site. Alternatively, the worker terminal 50 may be provided inside the construction machinery to display the trench excavation work plan on a screen. The worker terminal 50 may perform a machine guidance function or a machine control function. When the construction machinery is an automatic excavator, the worker terminal 50 may control an operation of the automatic excavator.

Thus, the administrator may input the work data for creating the trench excavation work plan to the server 100, and the server 100 may set the trench excavation work plan by using the work data and the construction site information. The server 100 may transmit the trench excavation work plan to the external or built-in worker terminal on the construction machinery or an administrator terminal owned by the administrator. The worker may proceed with work through the trench excavation work plan displayed on the screen, and may operate an unmanned construction machine through the trench excavation work plan.

Referring to FIG. 16, the server 100 may create the trench excavation work plan for the construction machinery on the orthographic image through the work planning portion 400.

First, the orthographic image and the earthwork drawing may be set as a background (S200). The background may be a basic background for creating the trench excavation work plan. Setting the orthographic image and the earthwork drawing as the background may be processed in a background setting unit 410.

In example embodiments, the background setting unit 410 may overlay the orthographic image and the earthwork drawing. Accordingly, the earthwork drawing may be displayed overlaid on the orthographic image of the construction site.

In example embodiments, the display device 110 and the worker terminal 50 may display the orthographic image and the earthwork drawing overlaid with each other. The overlaid orthographic image and the earthwork drawing may include a same reference coordinate BP and may have a same coordinate at a same point.

In example embodiments, the orthographic image and the earthwork drawing may include the reference coordinate BP. The overlaid orthographic image and earthwork drawing may have the same reference coordinate BP.

Then, a plurality of the sequence points at which construction work is performed may be set on the orthographic image (S210), and a sequence number may be set for each sequence point by reflecting a work order (S220). Setting a plurality of the sequence points and setting the sequence number may be processed by a planar design unit 420.

In example embodiments, the sequence point may be a point at which the operation is performed. The sequence point may include a point at which the work starts, a point at which the work ends, a point at which the work changes, and the like. A plurality of the sequence points may be input according to the work order in which the construction work is performed.

In example embodiments, the planar design unit 420 may classify a plurality of the sequence points input by the administrator, and the planar design unit 420 may interpret a first input sequence point as a starting point SP and a last input sequence point as an ending point EP according to the work order.

Also, the planar design unit 420 may sequentially assign the unique number to each of the sequence points. For example, the sequence points may be assigned the unique number PN1, PN2, PN3, PN4 according to the work order in which the construction work is performed. The display device 110 may display a plurality of the sequence points input by the administrator with the unique numbers PN1, PN2, PN3, PN4 assigned according to the work order in which the construction work is performed.

Then, the work route line connecting the sequence points according to the work order may be set (S230). Setting the work route line may be processed by the planar design unit 420.

The work route line may be connected according to the sequence of the unique numbers PN1, PN2, PN3, PN4 of the sequence points assigned sequentially. The work route line may be formed of a straight line or a curved line according to the order of the sequence points. The planar design unit 420 may assign the unique number to the work route line connecting the sequence points. The unique number L1, L2, L3 may be sequentially assigned to the work route line according to the order in which the construction work is performed.

Then, the cross-sectional shape and a work area shape for a plurality of the sequence points may be set (S240). Setting the cross-sectional shape and the working area shape may be processed by a cross-sectional design unit 430.

In example embodiments, when the construction work is to implement the trench excavation using the excavator, the administrator may set each dimension for a bottom width, a bottom elevation, a slope inclination and a top width of the cross-sectional shape as the work data.

In example embodiments, the cross-sectional design unit 430 may create the work area shape in a three-dimensional coordinate by reflecting the work route line on a plane through the cross-sectional shape input for each sequence point. The display device 110 may display the work area shape as a 3D coordinate set based on the reference coordinate BP.

Specifically, the cross-sectional design unit 430 may create the work area shape with the three-dimensional coordinate composed of a slope and a bottom surface by connecting the cross-sectional shape input at each sequence point along the work route line on the plane. The work area shape may be created by connecting a top surface, the bottom surface and both side surfaces constituting the cross-section shape of each sequence point in a direction of the work route line. Each dimension of the top surface, the bottom surface and both side surfaces may be obtained based on the dimension of the cross-sectional shape input based on the sequence points.

For example, the three-dimensional coordinate may be set based on the reference coordinate BP (x0, y0, z0) for each sequence point and the cross-sectional shape.

Then, a construction tolerance range for the dimension of the cross-sectional shape may be set (S250). Setting the construction tolerance range may be processed by an error setting unit 440.

The construction tolerance range may include an error range of all dimensions that may occur in the process of performing the construction work. The construction tolerance range may be set in an absolute unit such as a distance (m) or may be set in a relative unit such as a ratio (%).

In example embodiments, when the construction work is to implement the trench excavation, an administrator may set an error range for the bottom width, the bottom elevation, the slope inclination and the top width of the cross-sectional shape. In addition, the construction tolerance range may include an error range for the protrusion degree of the bottom surface and the slope.

Then, the work position of the construction machinery may be set based on the work route line (S260). Setting the work position of the construction machinery may be processed in a work position setting unit 450.

In example embodiments, the work position may be set to a specific position of the construction machinery. The work position may include a movement route of the construction machinery.

In example embodiments, the work position setting unit 450 may specific position or set the movement route of the construction machinery on the orthographic image. Setting the work position of the construction machinery may set the position of the construction machinery to any one of a left, a right and a center based on the work route line.

The work position setting unit 450 may set a plurality of movement points including a starting point MN1 and an ending point MN4 of the movement route through the data input by the administrator to the terminal 60. The work position setting unit 450 may set a way point MN2, MN3 between the starting point and the ending point of the movement route.

For example, the administrator may input a plurality of movement points to the server 100 according to the work order, and a first input movement point may be set as the starting point MN1 and a last input movement point may be set as the ending point MN4.

The work position setting unit 450 may set a movement line connecting the movement points according to the movement route on which the construction machinery moves. The movement line may be expressed in a direction of an arrow according to a progress sequence in which the construction work is performed. The direction of the arrow may be displayed from the movement line that a pre-work is done to the movement line that a post-work is done.

The work position setting unit 450 may assign the unique number to the movement line. The unique numbers ML1, ML2, ML3 may be sequentially assigned to the movement line according to the order in which the construction work is performed. The work position setting unit 450 may convert a coordinate of the movement line based on the reference coordinate BP.

Then, a moving direction of a vehicle to load the soil or a filling direction of the soil may be set by reflecting the work position of the construction machinery (S270). Setting the moving direction of the vehicle to load the soil or the filling direction of the soil may be processed by a soil treatment setting unit 460.

In example embodiments, a soil treatment method may include loading the soil on a cargo vehicle, transporting the soil by the cargo vehicle and filling a built-up soil. The soil treatment method may reflect the movement route of the construction machinery. Specifically, the soil treatment method may be set differently depending on the location along the movement route of the construction machinery.

Specifically, when the soil treatment method is to load and transport a cargo vehicle, the soil treatment setting unit 460 may set the moving direction of the cargo vehicle. Setting the moving direction of the cargo vehicle may reflect the work position of the construction machinery set based on the work route line.

Setting the moving direction of the vehicle may include setting the moving direction of a loading box constituting the cargo vehicle for transport. The administrator may set the forward/backward moving direction of the cargo vehicle for transport.

When the soil treatment method is to form an embankment, a formation direction of the embankment may be set. Setting the formation direction of the embankment may be set by reflecting the work position of the construction machinery set based on the work route line.

Then, a manned work area may be set (S280). Setting the manned work area may be processed by a manned work section setting unit 470.

In example embodiments, the construction machinery may be the excavator, and the excavator may be the automatic excavator. When the excavator is the automatic excavator, the work area may be classified as the manned work area or the remoted work area.

The manned work section setting unit 470 may set the manned work area or the remoted work area by reflecting the work route line connecting the sequence points and the cross-sectional shape of the sequence points. The manned work area or the remoted work area may be set by reflecting the work data on the work position of the construction machinery input by the administrator.

As described above, the method of making the work plan for the construction machinery may create a more uniform work detail. In addition, it may be possible to more accurately share the trench excavation work plan among related parties such as excavation construction managers including excavator drivers. Furthermore, it may be possible to give more precise commands to the fully automatic excavators.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present disclosure. Accordingly, all such modifications are intended to be included within the scope of example embodiments as defined in the claims.

1. A method of making a work plan for construction machinery, the method comprising:
providing construction site information including an orthographic image and work data;
setting a trench excavation work plan on the orthographic image based on the work data, the trench excavation work plan displaying a work route line and a work position of construction machinery based on the work route line; and
transmitting the trench excavation work plan to a worker terminal.

2. The method of claim 1, wherein setting the trench excavation work plan includes,
setting a plurality of sequence points on the orthographic image;
setting a sequence number for each sequence point by reflecting a work sequence; and
setting the work route line by connecting the sequence points according to the sequence number.

3. The method of claim 2, wherein setting the trench excavation work plan further includes setting a cross-sectional shape for the sequence points.

4. The method of claim 3, wherein setting the cross-sectional shape includes,
setting each dimension for a bottom width, a bottom elevation, a slope inclination and top width of the cross-sectional shape; and
setting a construction tolerance range for the bottom and the slope.

5. The method of claim 1, wherein the orthographic image includes a reference coordinate, and the work route line and the work position of the construction machinery are set based on the reference coordinate.

6. The method of claim 1, wherein setting the trench excavation work plan on the orthographic image further includes displaying on a screen by overlaying an earthwork drawing on the orthographic image.

7. The method of claim 1, wherein setting the trench excavation work plan further includes setting a moving direction of a vehicle to load soil or a filling direction of the soil by reflecting the work position of the construction machinery.

8. The method of claim 1, wherein the construction machinery is an automatic excavator and the worker terminal is provided in the automatic excavator to control an operation of the automatic excavator.

9. The method of claim 1, wherein setting the trench excavation work plan further includes setting a manned work area or a remoted work area.

10. A work planning system for construction machinery, the work planning system comprising:
a server configured to store construction site information including an orthographic image and work data, and including a work planning portion to set a trench excavation work plan on the orthographic image using the work data, the trench excavation work plan displaying a work route line and a work position of construction machinery based on the work route line; and
at least one worker terminal configured to receive the set trench excavation work plan from the server.

11. The work planning system of claim 10, wherein the work planning portion includes a planar design unit to set a plurality of sequence points having sequence numbers reflecting a work sequence on the orthographic image and to set the work route line by connecting the sequence points according to the sequence numbers.

12. The work planning system of claim 11, wherein the work planning portion further includes a cross-section design unit to set a cross-sectional shape of the sequence points.

13. The work planning system of claim 12, wherein the cross-section design unit sets each dimension for a bottom width, a bottom elevation, a slope inclination and top width of the cross-sectional shape, and the work planning portion sets a construction tolerance range for the bottom and the slope.

14. The work planning system of claim 10, wherein the orthographic image includes a reference coordinate, and the work route line and the work position of the construction machinery are set based on the reference coordinate.

15. The work planning system of claim 10, wherein the worker terminal displays on a screen by overlaying an earthwork drawing on the orthographic image.

16. The work planning system of claim 10, wherein the work planning portion includes a soil treatment setting unit to set a moving direction of a vehicle to load soil or a filling direction of the soil by reflecting the work position of the construction machinery.

17. The work planning system of claim 10, wherein the construction machinery is an automatic excavator and the worker terminal is provided in the automatic excavator to control an operation of the automatic excavator.

18. The work planning system of claim 17, wherein the work planning portion includes a manned work section setting unit to set a manned work area or a remoted work area.

19. A method of making a work plan for construction machinery, the method comprising:
providing construction site information including work data and an orthographic image having a reference coordinate;
setting a trench excavation work plan on the orthographic image using the work data, the trench excavation work plan displaying a work route line and a work position of construction machinery based on the work route line based on the reference coordinate; and
transmitting the trench excavation work plan to a worker terminal,
wherein setting the trench excavation work plan includes,
setting a plurality of sequence points on the orthographic image;
setting a sequence number by reflecting a work sequence for each sequence point; and
setting the work route line by connecting the sequence points according to the sequence number.
